(19) United States
(12) Patent Application Publication
(10) Pub. No.: US 2022/0357725 A1
(43) Pub. Date: Nov. 10, 2022

(54) MEASUREMENT DATA VALIDATION SYSTEM

(71) Applicant: VEGA Grieshaber KG, Wolfach (DE)

(72) Inventors: Juan GARCIA, Biberach (DE); Ralf HOELL, Titisee-Neustadt (DE)

(21) Appl. No.: 17/741,248

(22) Filed: May 10, 2022

(30) Foreign Application Priority Data
May 10, 2021 (DE) 10 2021 112 142.6

(51) Int. Cl. G05B 19/418

(52) U.S. Cl. CPC G05B 19/41815; G05B 19/41855; G05B 2219/25062; G05B 2219/25428

(57) ABSTRACT

A measurement data validation system for validating measurement data of a field device is provided. The measurement data validation system includes a field device, a position detection device and/or a measurement station detection device, and a server. The field device acquires measurement data of a measurement station and transmits the acquired measurement data to the server. The position detection device detects a position of the measurement station and transmits the detected position to the server. The measurement station detection device can detect a measurement station parameter and transmit the parameter to the server. The server receives the sensed measurement data, the position of the measurement station or the measurement station parameter and verifies and/or validates the measurement data and/or instructs the field device to sense measurement data of the measurement station.

### CROSS-REFERENCE TO RELATED APPLICATIONS

This application claims the benefit of the filing date of German Patent Application No. 10 2021 112 142.6 filed on 10 May 2021, the entire content of which is incorporated herein by reference.

### FIELD OF INVENTION

The invention generally relates to the field of process automation or factory automation. In particular, the invention relates to a measurement data validation system for validating measurement data of a field device, a method for measurement data validation, a program element, and a computer-readable medium.

### BACKGROUND

In automation technology, sensors are used to detect a variety of process variables, such as a level, a density, a flow rate, a temperature and/or a pressure of a medium, in a variety of different containers with different geometries. In order to evaluate a measurement signal captured with the measuring device and to be able to determine meaningful values of the process variables to be determined, it may be necessary to carry out a parameterization in the respective measuring device that is suitable for the respective container and/or for the medium stored therein.

A field device can thus be individually configured for a specific vessel and a specific measurement environment. If, for example, the type of container in which the field device performs its measurement changes, it may be necessary to re-parameterize the field device so that it is again a valid measured value.

### SUMMARY

Embodiments of the present disclosure can advantageously ensure sufficient quality and measurement reliability of measurement data obtained from a field device.

A first aspect of the present disclosure relates to a measurement data validation system for validating measurement data of a field device. The measurement data validation system comprises a field device, a position detection device and/or a measurement station detection device, and a server. The field device is configured to acquire, i.e., capture or record, measurement data of a measurement point, i.e., a measurement post or station, and to transmit the acquired measurement data to a server. The position detection device is configured to detect a position of the measurement station and to transmit the detected position to the server as well. Alternatively or additionally, the measurement station detection device is arranged to detect a measurement station parameter and to transmit the detected measurement station parameter to the server. The server is configured to receive the sensed measurement data, the position of the measurement station or the measurement station parameter and, based on the sensed position and/or the sensed measurement station parameter, to check and/or validate the measurement data and/or, based on the sensed position and/or the sensed measurement station parameter, to instruct the field device to sense measurement data of the measurement point.

In other words, based on the position and/or a measurement station parameter, the server may validate, check for validity and/or accuracy, or verify the measurement data collected by the field device. The term “based on” is to be understood broadly in the context of the present disclosure. For example, this expression may mean “dependent on,” “influenced by,” or “conditional on.” Alternatively or additionally, the server may instruct the field device to acquire measurement data, where the instructing may depend on the acquired position of the measurement station and/or the acquired measurement station parameter. This may mean, for example, that it is checked whether the measurement station is correctly positioned or corresponds to a predetermined position, and that as far as the position of the measurement station is evaluated as correct or proper, the field device may be instructed to acquire measurement data and/or the already acquired measurement data may be validated. Alternatively or additionally, it can be checked whether the measurement station parameter is correct or corresponds to a predefined measurement station parameter and that as far as the measurement station parameter is evaluated as correct or correct, the field device can be instructed to acquire measurement data and/or the already acquired measurement data can be validated. The position of the measurement station can be detected with the position detection device. The measurement station parameter can be detected with the measurement station detection device.

The terms “measuring point”, “measuring station” or “measuring post” are to be understood broadly in the context of the present disclosure. They may refer to one or more containers, to a storage facility, to a conveyor belt, to a container or conveyor belt, or generally to an area. It should be noted that the measurement station may be a movable or mobile measuring point. The measurement data may be any type of measured quantities and/or physical quantities. Alternatively or additionally, the measurement data may correlate with or be representative of a physical quantity. For example, it may be a measured signal that is representative of a fill level of a container. The measurement data can also be, for example, a measured pressure, a measured temperature or similar.

The measurement station position may be an orientation, a slope, a geographic position, an angle of attack, an altitude, and/or a combination of several measurement station position parameters. The measurement station parameter may generally be any type of parameter that defines, characterizes, describes, distinguishes, specifies, and/or identifies the measurement point. The term “measurement station parameter” is to be understood broadly in the context of the present disclosure.

In particular, the position detection device can be arranged in or on the container to detect the position of the container. The position detection device may also be arranged in or on the field device to detect the position of the field device. Additionally, the position detection device or server may be provided to detect the relative position of the field device and the container. In particular, multiple sensors may be provided for the position detection devices, one in or on the container (to determine the position of the container) and another in or on the field device (to determine the position of the field device).

The field device can be one or more sensors of any type. For example, it may be a level sensor, a pressure sensor, a flow sensor, a temperature sensor, an analytical sensor, and/or a station level sensor.

The server can generally be a central server. The server can, for example, communicate with several field devices or exchange data and/or signals. The server may be a computer, a cloud, a control device, and/or a controller. A validation list may be stored in the server. For example, a validation list may comprise a plurality of criteria and/or conditions, each of which may be negatively or positively satisfied. Alternatively or additionally, predetermined conditions may be stored and/or saved in the server.

It should be noted that the validation and/or verification of the measurement data can be performed by means of the server or directly in the field device in an automated or mainly automated way.

According to an embodiment, the field device is further configured to wirelessly transmit the sensed measurement data to the server. Alternatively or additionally, the position detection device is further configured to wirelessly transmit the detected position to the server. Alternatively or additionally, the measurement station detection device is further configured to wirelessly transmit the detected measurement station parameter to the server.

In other words, the field device may communicate and/or exchange data with the server via radio, i.e. wirelessly. Alternatively or additionally, the position detection device and/or the measurement station detection device may communicate and/or exchange data with the server via radio, i.e. wirelessly. It should be noted that the measurement data and/or the position can alternatively also be transmitted by wire.

According to an embodiment, the server is further configured to send a message based on the verification and/or validation of the measurement data. The server may send a warning signal, an error message, an acoustic message and/or a visual message. The message may generally be an event-based message. The message may be representative of the verification and/or validation. For example, a green light may be sent if the measurement data has been positively validated. It should also be noted that the server may send as a message a signal that includes or triggers forwarding of the actual message to a device, such as forwarding an audible alarm to a mobile device.

According to an embodiment, the server is adapted to provide the measurement data with a status signal based on the verification and/or validation of the measurement data. The term “status signal” is to be understood broadly in the context of the present disclosure. For example, it may be a “flag”. Alternatively or additionally, the measurement data may be sent or transmitted to the server in a generally recognizable manner. For example, technologies may be used to recognize the measurement data, such as RFID tags and object recognition systems.

According to an embodiment, the server is further configured to generate validation results based on the verification and/or validation of the measurement data. In addition, the server is further adapted to transmit the validation results to the field device and/or to a higher-level system. The term “validation result” is to be understood broadly in the context of the present disclosure. For example, it may be a validation list, which may be stored in the server. Such a validation list may store whether the measurement station is correctly positioned and/or whether the measurement station parameter is the correct measurement station parameter. It should be noted that the notion of “correct” may mean that the position and/or the measurement station parameter corresponds to an expected, predefined and/or predetermined position and/or measurement station parameter. In other words, the notion of “correct” may mean a fulfillment of a predetermined prerequisite. Whether such predetermined preconditions are fulfilled or not can be taken from the validation results, for example.

It should be noted that the higher-level system can be a PLC, DCS and/or SCADA system.

According to an embodiment, the position detection device is set up to detect the position of the measurement station based on one or more of the following listed methods, which can be used for distance measurement, for example: Inductive proximity methods, capacitive proximity methods, NFC methods, optical and/or magnetic methods. In other words, the position detection device may include inductive proximity sensors, capacitive proximity sensors, NFC modules, and optical or magnetic sensors, such as for detecting the distance to the container.

According to an embodiment, the measurement station detection device and the position detection device are designed as a single device. In other words, the measurement station detection device can be combined with the position detection device. The single device may be set to detect the position of the measurement station and/or the measurement station parameter.

According to an embodiment, the measurement station comprises a container and/or a conveyor belt. The measurement station may generally designate an area and/or a combination of several objects. In this regard, the measurement station may comprise a plurality of containers of the same type or of different types. The term “type” is to be understood broadly in the context of the present disclosure.

It should be noted that a geometry, such as a container geometry, of an object on the tape and a position, such as a container position, of the object on the tape can be detected and evaluated in the server, such as in the cloud, with respect to measurement validation. The position of the object on the belt may be, for example, a specific zone which should be reached. The belt may be a conveyor belt.

According to an embodiment, the measurement station parameter is a container parameter. Alternatively or additionally, the measurement station parameter comprises a measurement station geometry, a container geometry, a container content, and/or a container specification. The container parameter may be the container content, a container material, and/or a container type.

According to an embodiment, the measurement station detection device is arranged to detect the measurement station parameter based on one or more of the following listed methods: NFC method, RFID method, and/or optical method. In other words, the measurement station recognition (i.e. detection) device may comprise NFC systems, RFID systems, or optical camera systems.

According to an embodiment, the field device is a level sensor, a station level sensor, or a range monitoring sensor. The field device may further be, for example, a pressure sensor, a flow sensor, an analyzer, a limit switch, a temperature sensor, a valve, and/or generally a process or factory automation sensor.

Another aspect of the present disclosure relates to a method for measurement data validation from the field of process or factory automation. The method comprises the following steps:
Acquisition of measurement data of a measurement station by means of a field device;
Transfer of the acquired measurement data by means of the field device to a server;
Detection of a position of the measurement station by means of a position detection device; and/or
Acquisition of a measurement station parameter by means of a measurement station detection device;
Transmitting the detected position of the measurement station by means of the position detection device to the server; and/or
Transmitting the acquired measurement station parameter to the server by means of the measurement station detection device;
Receiving the measurement data, the position and/or the measurement station parameter by means of the server; and
Verifying and/or validating by means of the server the acquired measurement data based on the acquired position and/or the measurement station parameter.

According to one embodiment, the method further comprises the step of:
Instructing the field device to acquire or not to acquire measurement data of the measurement station based on the detected position and/or acquired measurement station parameter.

Another aspect of the present disclosure relates to a program element that, when executed on a measurement data validation system, directs the measurement data validation system to perform the following steps:
Acquisition of measurement data of a measurement station by means of a field device;
Transfer of the acquired measurement data by means of the field device to a server;
Detection of a position of the measurement station by means of a position detection device; and/or
Acquisition of a measurement station parameter by means of a measurement station detection device;
transmitting the detected position of the measurement station by means of the position detection device to the server; and/or
Transmitting the acquired measurement station parameter to the server by means of the measurement station detection device;
Receiving the measurement data, the position and/or the measurement station parameter by means of the server; and
Verifying and/or validating by means of the server the acquired measurement data, based on the acquired position and/or the measurement station parameter.

Another aspect of the present disclosure relates to a computer readable medium having stored thereon a program element as described above.

In the following, embodiments of the present disclosure are described with reference to the figures. If the same reference signs are used in the following description of figures, these designate the same or similar elements. The illustrations in the figures are schematic and not to scale.

### BRIEF DESCRIPTION OF THE FIGURES

FIG. 1 shows a measurement data validation system according to one embodiment.

FIG. 2 shows a measurement data validation system according to a further embodiment.

FIG. 3a/3b show a measurement data validation system according to a further embodiment.

FIG. 4 shows a measurement data validation system according to a further embodiment.

FIG. 5 shows a flow diagram of a process according to one embodiment.

### DETAILED DESCRIPTION

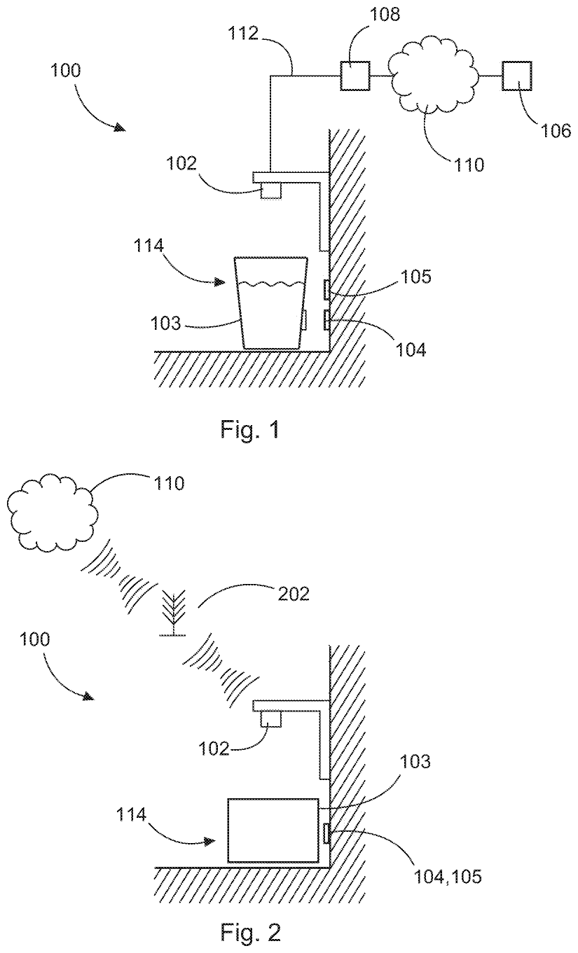

FIG. 1 shows a measurement data validation system according to an embodiment. The measurement data validation system 100 of FIG. 1 comprises a measurement device 102, such as a level sensor 102 or a station level sensor 102, and a server 110. In addition, the measurement data validation system may comprise either a position detection device 104 or a measurement station detection device 105, or both devices 104, 105. The measurement station 114 of FIG. 1 includes a container 103. The container 103 may, for example, be filled with a medium, such as a liquid medium or a medium containing bulk material.

The position detection device 104 may first detect whether the container 103, or the measurement station 114, is correctly positioned by having the position detection device detect the position of the container 103. The sensed position may be transmitted to the server 110 via cable or wire 112, i.e., via a wire 112. It should be noted that both the position detection device 104 and the measurement station detection device 105 may transmit data to the higher-level system 106 via a respective separate cable (not shown in FIG. 1), i.e., via a separate connection or line. Simultaneously or staggered, the field device 102 may collect measurement data and likewise transmit the data to the server 110 via a line 112 and possibly via an intervening higher-level system 108. The server 110 can receive the position of the container 103 as well as the acquired measurement data and, based on the position of the container 103, evaluate the measurement data such that the server 110 can verify and/or validate the measurement data. It is conceivable, for example, that the server 110 compares the position of the container 103 with a “target position” of the container 103 stored in the server 110, such as a predetermined position. Based on such comparison, the server 110 may evaluate whether the measurement data is valid and/or usable. In other words, based on the position of the measurement station 114, the server 110 may evaluate whether the measurement data is compromised, or may not be usable, due to an incorrect or inaccurate position of the measurement station 114.

Alternatively or additionally, a measurement station parameter may be captured by a measurement station detection device 105 and transmitted to the server 110 via a line 112. The server 110 may thus verify and/or validate the acquired measurement data based on the acquired measurement station parameter. For example, the measurement station parameter may be a predetermined content to be found in the container 103 of the measurement station 114. In this case, the corresponding predetermined measurement station parameter may be stored or presented in the server 110. If the detected measurement station parameter matches the predetermined measurement station parameter, the server 110 may, for example, consider the measurement data to be valid and thus positively validate it.

The measurement data may be deemed valid or usable if the measurement station parameter has been deemed correct or accurate by the server 110, or if the position of the measurement station 114 has been deemed correct or accurate. Alternatively, the measurement data may be deemed valid, i.e., positively validated, if both the measurement station parameter and the position of the measurement station 114 are correct.

Equally conceivably, the field device 102 may be directed by the server 110 to acquire or not acquire the measurement data based on the acquired measurement station parameter and/or based on the acquired position of the measurement station 114. For example, the server 110 may enable acquisition of measurement data only when the measurement station parameter has been deemed correct or accurate or when the position of the measurement station 114 has been deemed correct or accurate. Alternatively, the acquisition may not be enabled until both the measurement station parameter and the position of the measurement station 114 have been deemed correct or accurate.

The position detection device 104 and the measurement station detection device 105 are two different devices in the embodiment of the measurement data validation system 100 of FIG. 1. In a particular embodiment, these could also act as a combination device.

In particular, the position detection device 104 may be arranged in or on the container to detect the position of the container. The position detection device 104 may also be arranged in or on the field device to detect the position of the field device. Additionally, it may be provided that the position detection device 104 or the server detects the relative position of the field device and the container. In particular, multiple sensors may be provided for the position detection device 104, one in or on the container (to determine the position of the container) and another in or on the field device (to determine the position of the field device).

The measurement data validation system 100 of FIG. 1 may further comprise a system 108, such as a higher-level system 108, which is arranged to receive measurement data, signals, and/or information for the time being and to forward them to the server 110. The higher-level system may also be seen as a local control system (DCS) or programmable logic controller (PLC). In turn, the server 110 may, for example, forward validation results to another system, such as a higher-level system 106.

FIG. 2 shows a measurement data validation system 100 according to a further embodiment. Unless otherwise described, the measurement data validation system 100 of FIG. 2 has the same features and elements as the measurement data validation system 100 of FIG. 1. In the embodiment of FIG. 2, the transmission of the measurement data, the position of the measurement station and/or the measurement station parameter are transmitted wirelessly to the server 110. The server 110 may in turn transmit, for example, validation results to another system, such as a higher-level system 106 (as shown in FIG. 1). The transmission of measurement data may further be performed via a wireless network 202. For this purpose, the position detection device 104, the measurement station detection device 105, the field device 102 and/or the server may be provided with a corresponding interface. For example, the various components may have a radio interface. It should be noted that a combination of wireless and wired communication between the different components, i.e. between the field device 102 and the server 110, between the position detection device 104 and the server 110 and/or between the measurement station detection device 105 and the server 110, is conceivable.

In the embodiment of FIG. 2, the position detection device 104 and the measurement station detection device 105 are implemented as a single device. It should be noted that the measurement station 114 of the measurement data validation system 100 of FIG. 2 may comprise any object at which, for example, data may be acquired. Moreover, such a measurement station 114 may be not only the object, but also the general area around the object. It should be noted that the object may be a container with a medium such as liquid. In practice, such containers may be, for example, IBC containers.

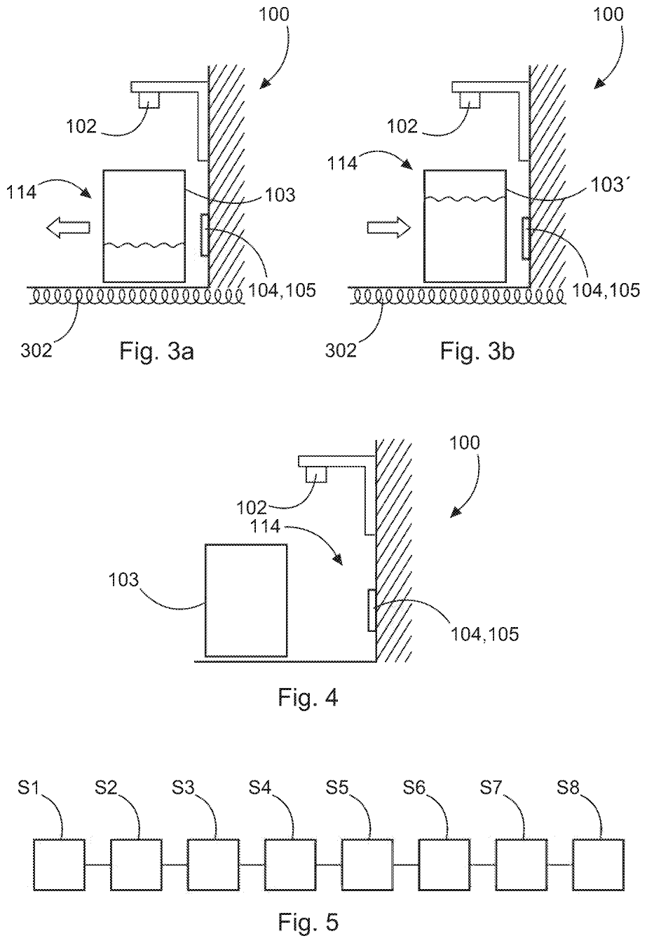

FIGS. 3a and 3b each show a measurement data validation system 100 according to a further embodiment. Unless otherwise described, the measurement data validation system 100 of FIGS. 3a and 3b has the same features and elements as the measurement data validation system 100 of FIGS. 1 and 2. The server 110 and the associated communication paths, wired or wireless, which may already exist in practice, are omitted in FIGS. 3a and 3b for clarity. At the measurement station 114 of FIGS. 3a and 3b, it can be seen that one container 103 is exchanged for another container 103′. The two containers 103, 103′ can have a different geometry and/or be filled with a different medium, for example. If the geometry of the containers 103, 103′ is different, negative measurement station detection on the part of the measurement station detection device 105 may occur. It is possible that the position detection device 104 may have detected that in both cases the container 103, 103′ is correctly positioned. However, the server 110 may be set in such a way that both conditions, i.e. position and measurement station parameters of the measuring point, must be fulfilled in order to be able to generate a positive validation result and/or in order to positively validate the measurement data at all.

The measuring station 114 of FIGS. 3a and 3b may further include a conveyor 302. The respective container 103, 103′ may, for example, be moved by means of the conveyor belt 302. However, it is conceivable that a container 103, 103′ is already movable or mobile without such a conveyor belt. The position of the measurement station 114 can be understood, for example, as the position of the object, i.e. the container 103, 103′ and/or another object, on the conveyor belt.

FIG. 4 shows a measurement data validation system 100 according to a further embodiment. Unless otherwise described, the measurement data validation system 100 of FIG. 4 has the same features and elements as the measurement data validation system 100 of FIGS. 1, 2, 3a and 3b. The server 110 and the associated communication paths, wired or wireless, which may already exist in practice, are omitted in FIG. 4 for clarity.

In the case of the measurement station 114 of the measurement data validation system 100 of FIG. 4, it can be seen that the container 103 is not positioned correctly. For example, the embodiment of the measurement data validation system 100 of FIG. 4 may validate and/or verify the measurement data based only on the detected position of the measurement station 114. This may be advantageous, for example, for containers of the same type, such as IBC containers. Alternatively or additionally, based on the sensed position of the measurement station 114, the server 110 (not shown in FIG. 4) may instruct the measurement device 102 to acquire the measurement data. In the case of FIG. 4, the server 110 will negatively validate the already acquired measurement data, or evaluate it as invalid because the measurement station container 103 is not properly positioned. In this case, the acquisition of a measurement station parameter may be omitted. Alternatively or additionally, the server may refuse to allow the field device 102 to acquire measurement data because the container 102 is not properly positioned.

Conceivably, the server 110 may send a message based on the detected position of the measurement station 114 and/or based on the detected measurement station parameter. For example, the server 110 may send an audible or visual message, such as a red light, informing a user that the container 103, or the measurement station 114, is not properly positioned. The server 110 may also transmit to a mobile device, such as a cell phone, a message (email, SMS, or the like) so that a user of the measurement data validation system 100 may be informed whether the measurement data has been positively or negatively validated and/or whether the field device 102 has been instructed to acquire measurement data.

FIG. 5 shows a flow diagram of a method for measurement data validation from the field of process or factory automation according to one embodiment. In a first step S1 of the method, measurement data of a measurement station 114 is acquired by means of a field device 102. In a further step S2, the acquired measurement data is transmitted or forwarded by means of the field device 102 to a server 110 by wire or wirelessly. In a further step S3, a position of the measurement station 114 is detected by means of a position detection device 104. Alternatively or additionally, a measurement station detection device 105 may detect a measurement station parameter in a step S4. In steps S5 and S6, the detected position and/or the detected measurement station parameter are transmitted to the server 110 by wire or wirelessly. In a further step S7, the server 110 receives the measurement data, the position and/or the measurement station parameter. Thereupon, in a step S8, the server can check and/or validate the measurement data based on the detected position and/or the measurement station parameter.

Alternatively or additionally, in a further step (not shown in FIG. 5) or in a substitute step, the field device 102 may instruct the server 110 to acquire additional measurement data based on the detected position and/or the acquired measurement station parameter.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A measurement data validation system configured to validate measurement data of a field device, comprising:
a field device configured to acquire measurement data from a measurement post and to transmit the acquired measurement data to a server;
a position detection device configured to detect a position of the measurement station and to transmit the detected position to the server; and/or
a measurement station detection device configured to acquire a measurement station parameter and to transmit the acquired measurement station parameter to the server;
a server configured to receive the acquired measurement data, the detected position of the measurement station or the acquired measurement station parameter and, based on the detected position and/or the acquired measurement station parameter, to check and/or validate the measurement data and/or, based on the detected position and/or the acquired measurement station parameter, to instruct the field device to acquire further measurement data of the measurement station.

2. The measurement data validation system according to claim 1,
wherein the field device is further configured to wirelessly transmit the acquired measurement data to the server; and/or
wherein the position detection device is further configured to wirelessly transmit the detected position to the server; and/or
wherein the measurement station detection device is further configured to wirelessly transmit the acquired measurement station parameter to the server.

3. The measurement data validation system according to claim 1,
wherein the server is further configured to send a message based on the verification and/or validation of the measurement data.

4. The measurement data validation system according to claim 1,
wherein the server is configured to provide the measurement data with a status signal based on the verification and/or validation of the measurement data.

5. The measurement data validation system according to claim 1,
wherein the server is further configured to generate validation results based on the verification of the measurement data.

6. The measurement data validation system according to claim 1,
wherein the server is further configured to generate validation results based on the validation of the measurement data.

7. The measurement data validation system according to claim 6, wherein the server is further configured to transmit the validation results to the field device and/or to a higher-level system.

8. The measurement data validation system according to claim 1,
wherein the position detection device is configured to detect the position of the measurement station based on one or more of the following listed methods: Inductive proximity method, capacitive proximity method, NFC method, optical method, and/or magnetic method.

9. The measurement data validation system according to claim 1,
wherein the measurement station detection device and the position detection device are implemented as a single device.

10. The measurement data validation system according to claim 1,
wherein the measurement station comprises a container.

11. The measurement data validation system according to claim 1,
wherein the measurement station comprises a conveyor belt.

12. The measurement data validation system according to claim 1,
wherein the measurement station parameter is a container parameter.

13. The measurement data validation system according to claim 1,
wherein the measurement station parameter comprises a measurement station geometry, a container geometry, a container content, and/or a container specification.

14. The measurement data validation system according to claim 1,
wherein the measurement station detection device is configured to detect the measurement station parameter based on one or more of the following listed methods: NFC method, RFID method, and/or optical method.

15. The measurement data validation system according to any claim 1,
wherein the field device is a level sensor, a level limit sensor, or a range monitoring sensor.

16. A method for measurement data validation in the field of process automation or factory automation, the method comprising:
acquiring measurement data from a measurement station using a field device;
transmitting the acquired measurement data by means of the field device to a server;
detecting a position of the measurement station by means of a position detection device; and/or
acquiring a measurement station parameter by means of a measurement station detection device;
transmitting the detected position of the measurement station to the server by means of the position detection device; and/or
transmitting the acquired measurement station parameter to the server by means of the measurement station detection device;
receiving the acquired measurement data, the detected position and/or the acquired measurement station parameter by means of the server; and
verifying and/or validating by means of the server the acquired measurement data based on the detected position and/or the acquired measurement station parameter.

17. The method of claim 16, further comprising:
directing the field device to acquire further measurement data of the measurement station based on the detected position.

18. The method of claim 16, further comprising:
directing the field device to acquire further measurement data of the measurement station based on the acquired measurement station parameter.

19. A program element which, when executed on a measurement data validation system, instructs the measurement data validation system to perform the following steps:
acquiring measurement data from a measurement station using a field device;
transmitting the acquired measurement data by means of the field device to a server;
detecting a position of the measurement station by means of a position detection device; and/or
acquiring a measurement station parameter by means of a measurement station detection device;
transmitting the detected position of the measurement station to the server by means of the position detection device; and/or
transmitting the acquired measurement station parameter to the server by means of the measurement station detection device;
receiving the acquired measurement data, the detected position and/or the acquired measurement station parameter by means of the server; and
verifying and/or validating by means of the server the acquired measurement data based on the detected position and/or the acquired measurement station parameter.

20. A computer-readable medium on which is stored a program element according to claim 19.
